(19) United States
(12) Patent Application Publication
(10) Pub. No.: US 2026/0098411 A1
(43) Pub. Date: Apr. 9, 2026

(54) THERMAL BRACKET ASSEMBLY

(71) Applicant: LKME PRODUCTS LTD., Saanichton (CA)

(72) Inventors: Kevin PICKWICK, North Saanich (CA); Carter HOVEY, Victoria (CA); Matthew DALZELL, North Vancouver (CA); Roderick PARKER, Saanichton (CA)

(21) Appl. No.: 18/910,529

(22) Filed: Oct. 9, 2024

(51) Int. Cl. E04F 13/00; F16M 13/02

(52) U.S. Cl. CPC E04F 13/007; F16M 13/02

(57) ABSTRACT

A thermal bracket assembly is disclosed. The thermal bracket assembly comprises a mounting bracket and a clip. The mounting bracket has a bracket base plate, and a first bracket web and a second bracket web extending outwardly from the bracket base plate. The clip comprises a clip base plate and a clip web extending outwardly from a side of the clip base plate. The clip is securable to the mounting bracket by aligning one or more adjustment holes defined in the mounting base plate with one or more corresponding adjustment holes defined in the clip base plate, and inserting a fastener through the aligned adjustment holes.

### FIELD OF THE INVENTION

The invention pertains to thermal bracket assemblies, in particular, those for use to attach cladding to building structures.

### BACKGROUND

Thermal bracket assemblies are known in the art. The present invention is directed to an improved thermal bracket assembly that is adjustable, easy to install, is compatible with most cladding installations, strong, have good thermal properties, non-combustible, and/or is corrosion resistant.

### SUMMARY

The invention provides a thermal bracket assembly. The thermal bracket assembly is used to attach cladding to building structures. The thermal bracket assembly described herein may be used in rain screen walls and roof assemblies.

The thermal bracket assembly comprises a mounting bracket and a clip. The mounting bracket comprises a bracket base plate, a first bracket web and a second bracket web. In some embodiments, the first bracket web extends outwardly from a first side edge of the bracket base plate. In some embodiments, the second bracket web extends outwardly from a second side edge of the bracket base plate. In some embodiments, the first bracket web extends in a direction opposite from the direction to which the second bracket web extends.

The clip comprises a clip base plate and a clip web projecting outwardly from the clip base plate. In some embodiments, the clip web extends outwardly from the first side edge of the clip base plate.

A plurality of bracket holes and/or clip holes are defined in the bracket base plate and clip base plate respectively. The bracket holes and/or clip holes are oriented to decrease heat flow through the thermal bracket assembly, thereby improving thermal performance while providing the necessary structural capacity to support an exterior cladding to a building structure.

A plurality of adjustment holes and corresponding adjustment holes are defined in the bracket base plate and the clip base plate. The clip is securable to the mounting bracket. In use, a user aligns the corresponding adjustment hole defined in the clip base plate with one or more adjustment holes defined in the bracket base plate. A fastener is inserted through the aligned adjustment holes to secure the clip to the mounting bracket. The plurality of adjustment holes comprise adjustment holes that are separated from adjacent one or more adjustment holes by a space. In some embodiments, the distance between two adjustment holes is the same or substantially the same. The pre-punched adjustment holes in the bracket base plate advantageously facilitates the user in making precise, measured, adjustments of the thermal bracket assembly as desired during installation.

In some use embodiments, a user installs the thermal bracket assembly comprising the mounting bracket and the clip. In some use embodiments, only the mounting bracket is installed for use to attach cladding to building structures, i.e., the clip is omitted in the installation and that the mounting bracket may be used independent of the clip.

Further aspects of the invention and features of specific embodiments of the invention are described below.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 is a perspective view illustrating a thermal bracket assembly comprising a mounting bracket and a clip placed thereon, according to an example embodiment of the invention. FIG. 1 illustrates one example use application of the thermal bracket assembly.

FIG. 2 is a perspective view illustrating the thermal bracket assembly of FIG. 1. FIG. 1 illustrates another example use application of the thermal bracket assembly.

FIG. 3 is a perspective view illustrating a mounting bracket of the thermal bracket assembly according to an example embodiment of the invention.

FIG. 4 is a perspective view illustrating a mounting bracket of the thermal bracket assembly according to another example embodiment of the invention.

FIG. 5 is a perspective view illustrating a clip according to an example embodiment of the invention.

### DETAILED DESCRIPTION

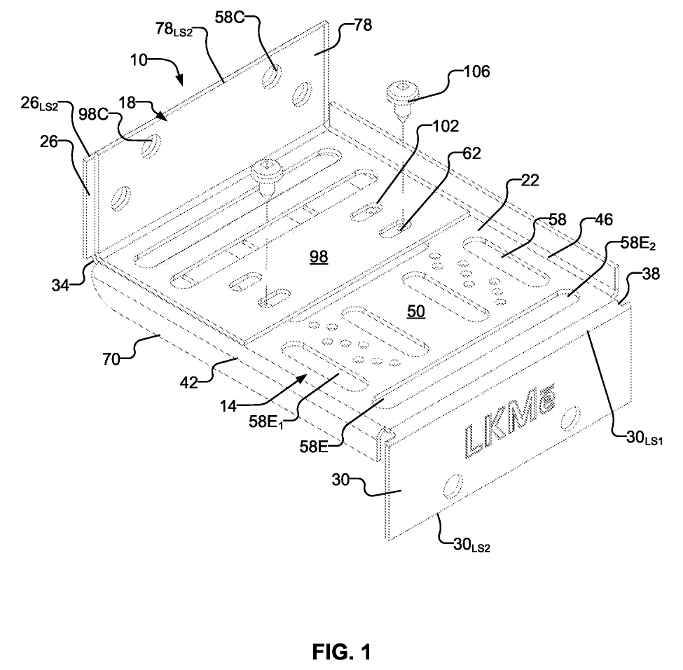

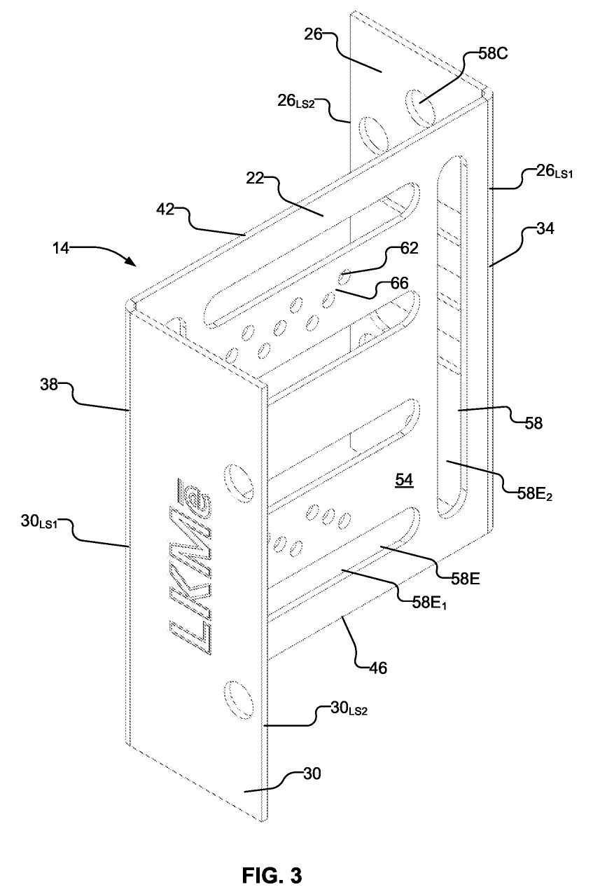

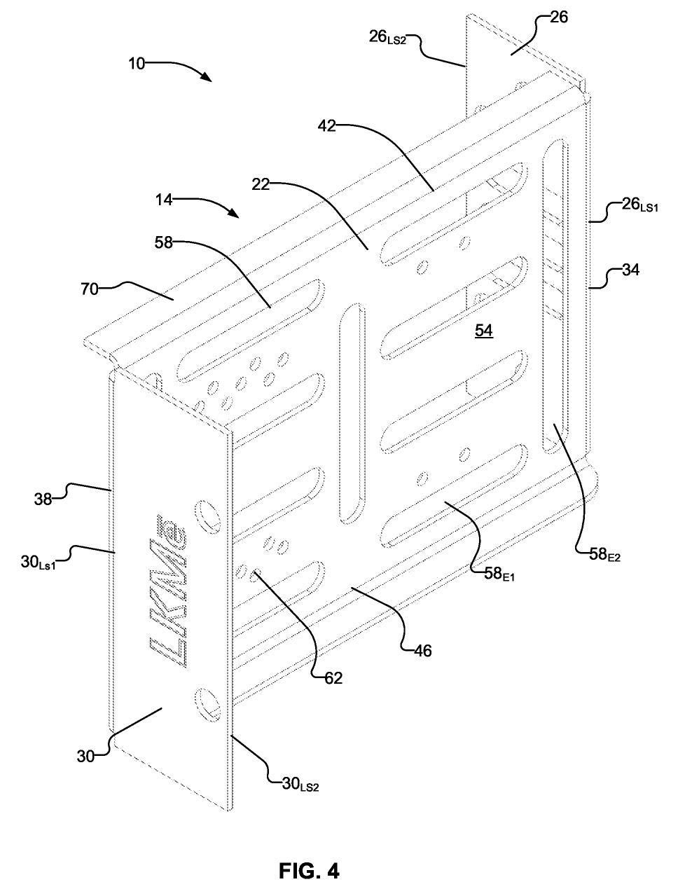

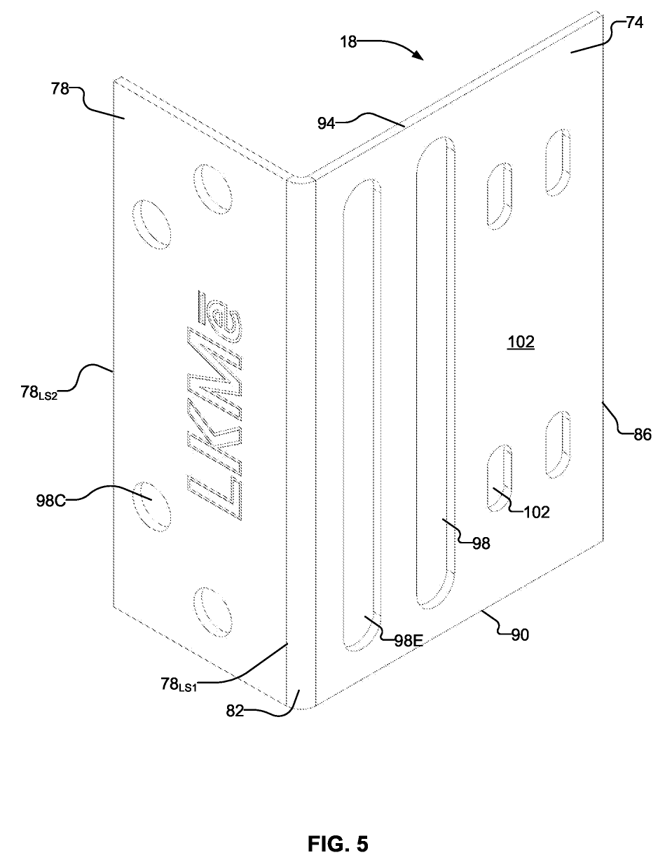

Referring to FIGS. 1-5, in one embodiment, the apparatus of the invention is a thermal bracket assembly 10. The thermal bracket assembly 10 comprises a mounting bracket 14 and a clip 18. The mounting bracket 14 comprises a bracket base plate 22, a first bracket web 26, and a second bracket web 30. The bracket base plate 22 has a first side edge 34, a second side edge 38 opposite to the first side edge 34, and a third side edge 42, and a fourth side edge 46 opposite to the third side edge 42. The third and fourth side edges 42, 46 connect with the first and second side edges 34, 38 to define a perimeter of the bracket base plate 22.

In some embodiments, the first and second side edges 34, 38 are oriented substantially parallel to one another. In some embodiments, the third and fourth side edges 42, 46 are disposed substantially parallel to one another. In some embodiments, the first and second side edges 34, 38 are oriented substantially orthogonal to the third and fourth side edges 42, 46. In some embodiments, the bracket base plate 22 has a rectangular configuration, with a length greater than a width thereof. In such embodiments, the lengths of the first and second side edges 34, 38 are shorter than the lengths of the third and fourth side edges 42, 46. In some embodiments, the bracket base plate 22 has a square configuration. The bracket base plate 22 may have a flat, or substantially flat, non-curved surface.

The first bracket web 26 and the second bracket web 30 are arranged to project outwardly from the bracket base plate 22. In some embodiments, the first and second bracket webs 26, 30 are arranged to project outwardly from the first and second side edges 34, 38 respectively. The first and second bracket webs 26, 30 may however be arranged to project outwardly from any point on a first or second surface 50, 54 of the bracket base plate 22. In some embodiments, the first and second bracket webs 26, 30 project away from opposing surfaces 50, 54 of the bracket base plate 22. The first bracket web 26 may be arranged to extend in a direction opposite from the direction to which the second bracket web 30 extends. In some embodiments, the first and/or second bracket web 26, 30 is arranged to project orthogonal to the bracket base plate 22. In some embodiments, the mounting bracket 14 has a generally Z-shaped cross-section.

The first and second bracket web 26, 30 comprises opposing first and second longitudinal side edges 26_{LS1}, 26_{LS2} and 30_{LS1}, 30_{LS2}. In some embodiments, the lengths of the first longitudinal side edges 26_{LS1},30_{L}_{S}₁ of the first and second bracket webs 26, 30 are the same or substantially the same as the first and second side edges 34, 38 of the bracket base plate 22 respectively. The first longitudinal side edges 26_{LS1},30_{LS1}of the first and second bracket web 26, 30 may be joined to the first and second side edges 34, 38 of the bracket base plate 22 respectively.

In some embodiments, the bracket base plate 22, the first bracket web 26 and the second bracket web 30 are integrally formed. In some embodiments, the first and second bracket webs 26, 30 are connected or attached to the bracket base plate 22.

A plurality of bracket holes 58 are defined in one or more of the bracket base plate 22, the first bracket web 26 and the second bracket web 30. The plurality of bracket holes 58 are oriented spaced-apart from each other. The plurality of bracket holes 58 are oriented to decrease heat flow through the mounting bracket 14, thereby improving thermal performance while providing the necessary structural capacity to support an exterior cladding to a building structure.

In some embodiments, the plurality of bracket holes 58 comprise one or more elongated bracket holes 58E. The elongated bracket holes 58E each has a length greater than a width thereof.

In some embodiments, the plurality of bracket holes 58 defined in the bracket base plate 22 comprise a first set of elongated bracket holes 58E₁ and a second set of elongated holes 58E₂. The first set of elongated bracket holes 58E₁may be arranged to extend longitudinally between the first and second side edges 34, 38 of the bracket base plate 22. In some embodiments, the first set of elongated bracket holes 58E₁comprises two or more elongated holes. The two or more elongated bracket holes may be arranged spaced-apart along a lateral axis of the bracket base plate 22. The second set of elongated bracket holes 58E₂may be arranged to extend longitudinally between the third and fourth side edges 42, 46 of the bracket base plate 22. In some embodiments, the second set of elongated bracket holes 58E₂comprises two or more elongated holes. The two or more elongated bracket holes may be arranged spaced-apart along a longitudinal axis of the bracket base plate 22. In some embodiments, the elongated bracket holes of the first set of elongated bracket holes 58E₁ are oriented between two elongated bracket holes of the second set of elongated holes 58E₂. In some embodiments, the elongated bracket holes in the first set of elongated bracket holes 58E₁ are oriented substantially perpendicular to the elongated bracket holes in the second set of elongated bracket holes 58E_{2.}

In some embodiments, the plurality of bracket holes 58 comprise holes that have a circular or substantially circular (including e.g., oval, ellipse, etc.) configuration. In some embodiments, one or both of the first bracket web 26 and the second bracket web 30 comprise circular or substantially circular bracket holes 58C (collectively referred to hereinafter as “circular holes 58C”). In some embodiments, at least one of the first bracket web 26 and the second bracket web 30 comprise elongated bracket holes 58E and circular bracket holes 58C. In some embodiments, the elongated bracket holes 58E comprise elongated bracket holes that are arranged to extend longitudinally between the respective first and second longitudinal side edges 26_{LS1}, 26_{LS2} and 30_{LS1}, 30_{LS2} of the bracket web 26, 30. In some embodiments, the plurality of elongated bracket holes 58E are arranged laterally spaced-apart from each other.

A plurality of adjustment holes 62 may be defined in the bracket base plate 22. The plurality of adjustment holes 62 comprise adjustment holes 62 that are separated from adjacent one or more adjustment holes 62 by a space 66. In some embodiments, the distance between two adjustment holes 62 is the same or substantially the same. In some example embodiments, the distance between two adjustment holes 62 is about 1/8” (about 3.175 mm). In some embodiments, the adjustment holes 62 are arranged between the elongated holes 58E, and in some embodiments, between two elongated holes of the first set of elongated holes 58E₁. The plurality of adjustment holes 62 may be oriented in groups of one or more sets of adjustment holes 62. In some example embodiments, each set of adjustment holes 62 comprises eight adjustment holes 62. In some example embodiments, each set of adjustment holes 62 is disposed between two elongated holes of the first set of elongated holes 58E₁. The pre-punched adjustment holes 62 in the bracket base plate 22 advantageously facilitates the user in making precise, measured, adjustments of the thermal bracket assembly 10 as desired during installation.

In some embodiments, a stiffener flange 70 is arranged to extend along one or both of the third and fourth side edges 42, 46 of the bracket base plate 22. The stiffener flange 70 is arranged to project outwardly from the respective side edge 42, 46. The stiffener flange 70 may extend along an entire length of the side edge 42, 46 or a portion thereof.

The clip 18 comprises a clip base plate 74 and a clip web 78 projecting outwardly from the clip base plate 74. The clip base plate 74 has a first side edge 82, a second side edge 86 opposite to the first side edge 82, and a third side edge 90, and a fourth side edge 94 opposite to the third side edge 90. The third and fourth side edges 90, 94 connect with the first and second side edges 82, 86 to define a perimeter of the clip base plate 74.

In some embodiments, the first and second side edges 82, 86 are oriented substantially parallel to one another. In some embodiments, the third and fourth side edges 90, 94 are disposed substantially parallel to one another. In some embodiments, the first and second side edges 82, 86 are oriented substantially orthogonal to the third and fourth side edges 90, 94. In some embodiments, the clip base plate 74 has a rectangular configuration, with a length greater than a width thereof. In such embodiments, the lengths of the first and second side edges 82, 86 are longer than the lengths of the third and fourth side edges 90, 94. In some embodiments, the clip base plate 74 has a square configuration. The clip base plate 74 may have a flat, or substantially flat, non-curved surface.

The clip web 78 is arranged to project outwardly from the clip base plate 74. In some embodiments, the clip web 78 is arranged to extend outwardly from the first and/or second side edge 82, 86 of the clip base plate 74. The clip web 78 may however be arranged to extend outwardly from any point on a first or second surface 98, 102 of the clip base plate 74. In some example embodiments, the clip web 78 is arranged to project outwardly from the first side edge 82, away from the first surface 98 of the clip base plate 74. In some embodiments, the clip web 78 is arranged to extend orthogonal to the clip base plate 74. In some embodiments, the clip 18 has a generally L-shaped cross-section.

The clip web 78 comprises opposing first and second longitudinal side edges 78_{LS1}, 78_{LS2}. In some embodiments, the length of the first longitudinal side edges 78_{LS1}of the clip web 78 is the same or substantially the same as the first side edge 82 of the clip base plate 74. The first longitudinal side edges 78_{LS1} of the clip web 78 may be joined to the first side edge 82 of the clip base plate 74.

In some embodiments, the clip base plate 74 and the clip web 78 are integrally formed. In some embodiments, the clip web 78 is connected or attached to the clip base plate 74.

A plurality of clip holes 98 are defined in one or both of the clip base plate 74 and clip web 78. The plurality of clip holes 98 are oriented spaced-apart from each other. In combination with the bracket holes 58, the plurality of clip holes 98 are oriented to decrease heat flow through the thermal bracket assembly 10, thereby improving thermal performance while providing the necessary structural capacity to support an exterior cladding to a building structure.

In some embodiments, the plurality of clip holes 98 comprise one or more elongated clip holes 98E. The elongated clip holes 98E each has a length greater than a width thereof. In some embodiments, the one or more elongated clip holes 98E are defined in the clip base plate 74. In some embodiments, the one or more elongated clip holes 98E are arranged to extend longitudinally between the third and fourth side edges 90, 94 of the clip base plate 74. In some embodiments, two or more elongated clip holes 98E are arranged spaced-apart along a lateral axis of the clip base plate 74.

In some embodiments, the plurality of clip holes 98 comprise holes that have a circular or substantially circular (including e.g., oval, ellipse, etc.) configuration. In some embodiments, the clip web 78 comprises circular or substantially circular bracket holes 98C (collectively referred to hereinafter as “circular holes 98C”).

In some embodiments, at least one corresponding adjustment hole 102 is defined in the clip base plate 74. The at least one corresponding adjustment holes 102 is positioned to align with at least one of the adjustment holes 62 defined in the bracket base plate 22 for a fastener 106 to insert therethrough when the clip 18 is placed on the mounting bracket 14. In some embodiments, the at least one adjustment hole 102 comprises a plurality of spaced-apart corresponding adjustment holes 102. In example embodiments in which the plurality of adjustment holes 62 comprise two sets of adjustment holes 62, at least two corresponding adjustment holes 102 are correspondingly positioned in the clip base plate 74. In some embodiments, the at least two corresponding adjustment holes 102 comprise four corresponding adjustment holes 102. In some example embodiments, the corresponding adjustment holes 102 are arranged spaced-apart from the elongated clip holes 98E along a lateral axis of the clip base plate 74.

The bracket base plate 22 and the clip base plate 74 may comprise any suitable dimensions (e.g., length and/or width). For example, the length of the bracket base plate 22 may be in the range of from about 1 inch to about 10 inches. The number of bracket holes 58 and the dimensions of the holes 58 may be adjusted based on and corresponding to the length of the bracket base plate 22. In some embodiments, the number and/or dimensions of the adjustment holes 62 may be adjusted based on and corresponding to the length of the bracket base plate 22. In some example embodiments, the depth of the mounting bracket 14 is about 3.0 inches.

The number and/or dimensions of the clip hole 98 may be adjusted based on and corresponding to the length of the clip base plate 74. In some example embodiments, the length of the clip base plate 74 is about 2.47 inches, and/or the depth of the clip 18 is about 1.53 inches.

The mounting bracket 14 and a clip 18 may be made of any material(s) that are suitable for use to attach cladding to a building structure. The material(s) selected for use to make the mounting bracket 14 and the clip 18 preferably comprise one or more of the following properties: high strength, lightweight, good thermal properties, and/or corrosion resistant. Suitable materials include but are not limited to aluminum, steel such as galvanized steel and stainless steel, fiberglass, etc. In some example embodiments, the mounting bracket 14 and/or the clip 18 are made of stainless steel.

The clip 18 is securable to the mounting bracket 14. The clip 18 may be secured to the mounting bracket 14 by using any suitable fasteners 106, such as nails, screws, bolts, and the like. In use, the clip 18 is positioned on the mounting bracket 14 such that the clip base plate 74 is placed in contact with the bracket base plate 22. The user aligns the corresponding adjustment holes 102 defined in the clip base plate 74 to the desired adjustment hole(s) 62 defined in the bracket base plate 22 by moving the clip 18 on the mounting bracket 14. The fastener 106 is inserted through the aligned adjustment holes 62, 102 and secured into the desired position.

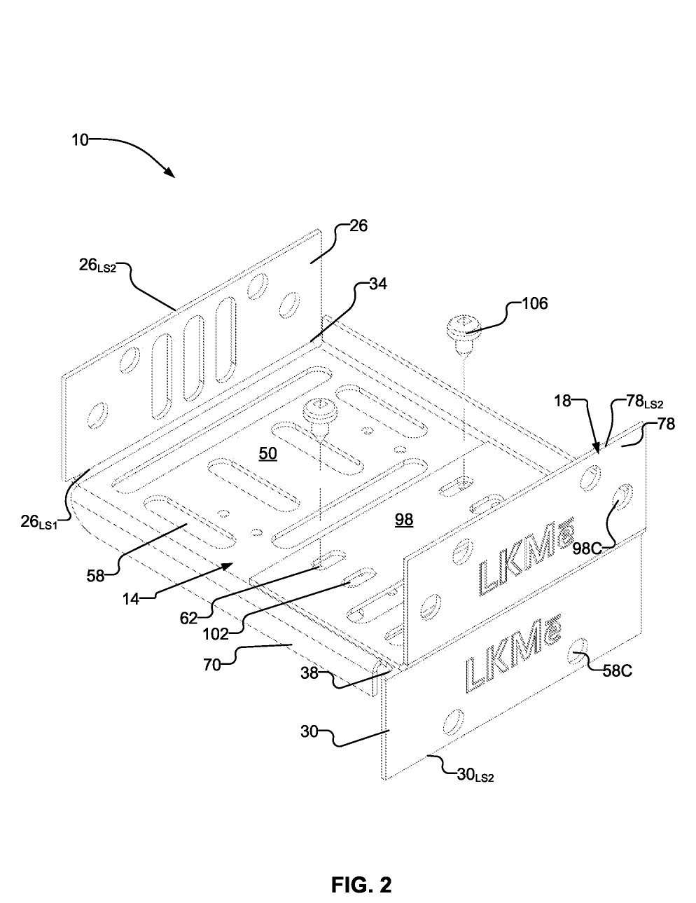

In some example use applications of the thermal bracket assembly 10, the clip 18 is used in conjunction with the mounting bracket 14 to allow the user to selectively extend the length of the mounting bracket 14 with precision (see e.g., FIG. 2). In such example use applications, the clip 18 is placed on the first surface 50 or the second surface 54 of the bracket base plate 22, arranged such that the clip web 78 extends outwardly from the bracket base plate 22 in the same direction as one of the first or the second bracket web 26, 30, and extends outwardly from the bracket base plate 22 in a direction opposite to the other one of the first or the second bracket web 26, 30. The clip web 78 may be arranged spaced-apart along the longitudinal axis of the bracket base plate 22 from the bracket web 26, 30 which extends outwardly from the bracket base plate 22 in the same direction as the clip web 78. The clip web 78 may be arranged spaced-apart along the longitudinal axis of the bracket base plate 22 from the other one of the bracket web 26, 30 which extends outwardly from the bracket base plate 22 in the opposite direction as the clip web 78. The clip web 78 may be disposed collinear with the other one of the bracket web 26, 30 which extends outwardly from the bracket base plate 22 in a direction opposite to the clip web 78. In some embodiments, the clip web 78 is disposed proximate to or placed in contact with the first or second side edge 34, 38 of the bracket base plate 22.

In some example use applications, the clip 18 is used in conjunction with the mounting bracket 14 to increase the strength of the mounting bracket 14 (see e.g., FIG. 1). In such example use applications, the clip 18 is placed on the first surface 50 or the second surface 54 of the bracket base plate 22, arranged such that the clip web 78 is placed adjacent to, along the longitudinal axis of the bracket base plate 22, or placed against, in contact with, the one of the first or the second bracket web 26, 30. The clip web 78 and the first or the second bracket web 26, 30 may extend outwardly from the bracket base plate 22 in the same direction. The clip web 78 may be arranged to extend parallel to the one of the first or the second bracket web 26, 30. The other one of the first or the second bracket web 26, 30 may be arranged to extend from the bracket base plate 22 in a direction opposite from the direction to which the clip web 78 extends.

In both use applications, the user positions the clip 18 on the mounting bracket 14, and aligns the corresponding adjustment hole(s) 102 defined in the clip base plate 74 to the desired adjustment hole(s) 62 defined in the bracket base plate 22. The user inserts a fastener 106 through the holes 62, 102, thereby securing the clip 18 to the mounting bracket 14 at the desired position.

In some example use applications of the thermal bracket assembly 10, the clip 18 is used in conjunction with the mounting bracket 14 to allow the user to selectively extend the width of the mounting bracket 14. In such example use applications, the clip 18 is placed on the first surface 50 or the second surface 54 of the bracket base plate 22, arranged such that the clip web 78 extends outwardly away from the third or the fourth side edge 42, 46 of the bracket base plate 22. In some embodiments, the clip web 78 extends substantially orthogonal to the stiffener flange 70. In some embodiments, the clip web 78 extends away from the bracket base plate 22 in the same direction as the stiffener flange 70. In some embodiments, the clip web 78 is disposed proximate to or placed in contact with the stiffener flange 70 of the bracket base plate 22.

In such use application, the user positions the clip 18 on the mounting bracket 14, and aligns the clip hole(s) 98 defined in the clip base plate 74 to the desired adjustment hole(s) 62 defined in the bracket base plate 22. The user inserts a fastener 106 through the holes 98, 102, thereby securing the clip 18 to the mounting bracket 14 at the desired position. The fastener 106 may be slideable along the clip hole(s) 98.

Throughout the foregoing description and the drawings, in which corresponding and like parts are identified by the same reference characters, specific details have been set forth in order to provide a more thorough understanding to persons skilled in the art. However, well known elements may not have been shown or described in detail or at all to avoid unnecessarily obscuring the disclosure.

As will be apparent to those skilled in the art in the light of the foregoing disclosure, many alterations and modifications are possible in the practice of this invention without departing from the scope thereof. Accordingly, the description and drawings are to be regarded in an illustrative, rather than a restrictive, sense.

1. A thermal bracket assembly comprising:
a mounting bracket comprising a bracket base plate, and a first bracket web and a second bracket web extending outwardly from the bracket base plate;
a clip comprising a clip base plate and a clip web extending outwardly from a side of the clip base plate,
wherein the clip is securable to the mounting bracket.

2. The thermal bracket assembly according to claim 1, wherein the first bracket web is arranged to extend from a first side edge of the bracket base plate, and/or the second bracket web is arranged to extend from an opposing second side edge of the bracket base plate.

3. The thermal bracket assembly according to claim 1, wherein the first bracket web and/or the second bracket web is arranged to extend orthogonal to the bracket base plate.

4. The thermal bracket assembly according to claim 1, wherein the first and second bracket webs are arranged to extend away from opposing surfaces of the bracket base plate.

5. The thermal bracket assembly according to claim 1, further comprising a plurality of adjustment holes being defined in the bracket base plate, wherein the plurality of adjustment holes are arranged spaced-apart from one another, each adjacent pair of adjustment holes being separated by a space.

6. The thermal bracket assembly according to claim 5, wherein the spaces being defined by distances separating adjacent pairs of the plurality of adjustment holes are equal or substantially equal.

7. The thermal bracket assembly according to claim 5, further comprising at least one mounting hole being defined in the clip base plate, wherein the clip base plate being slideable along the mounting bracket to align the at least one mounting hole with one or more of the plurality of the adjustment holes in the bracket base plate.

8. The thermal bracket assembly according to claim 7, further comprising one or more fasteners insertable through an aligned one or more of the at least one mounting hole in the clip base plate with the one or more of the plurality of the adjustment holes in the bracket base plate for securing the clip to the mounting bracket.

9. The thermal bracket assembly according to claim 1, further comprising one or more holes defined in the bracket base plate and/or the clip base plate.

10. The thermal bracket assembly according to claim 9, wherein the one or more holes comprise one or more elongated holes each having a length greater than a width thereof.

11. The thermal bracket assembly according to claim 10, wherein the one or more elongated holes defined in the clip base plate are each arranged to extend longitudinally along a longitudinal axis of the clip base plate.

12. The thermal bracket assembly according to claim 11, wherein the one or more elongated holes defined in the clip base plate comprise at least two elongated holes, the at least two elongated holes being arranged spaced-apart from each other along a lateral axis of the clip base plate.

13. The thermal bracket assembly according to claim 10, wherein the one or more elongated holes defined in the bracket base plate comprises a first set of elongated holes and a second set of elongated holes, the first set of elongated holes being oriented substantially perpendicular to the second set of elongated holes.

14. The thermal bracket assembly according to claim 13, wherein the first set of elongated holes comprises two or more elongated holes each being arranged to extend longitudinally between the first side edge and the second side edge of the bracket base plate, and wherein the two or more elongated holes are arranged spaced-apart along a lateral axis of the bracket base plate.

15. The thermal bracket assembly according to claim 13, wherein the second set of elongated holes comprises two or more elongated holes each being arranged to extend longitudinally between a third side edge and an opposing fourth side edge of the bracket base plate, and wherein the two or more elongated holes are arranged spaced-apart along the longitudinal axis of the bracket base plate.

16. The thermal bracket assembly according to claim 13, wherein the second set of elongated holes are disposed between two of the elongated holes in the first set of elongated holes.

17. The thermal bracket assembly according to claim 13, wherein the plurality of adjustment holes defined in the bracket base plate are disposed between two elongated holes in the first set of elongated holes.

18. The thermal bracket assembly according to claim 1, further comprising one or more holes defined in one or more of the first bracket wall, second bracket web and the clip web.

19. The thermal bracket assembly according to claim 1, further comprising first and second stiffener flanges extending along a third side edge and an opposing fourth side edge of the bracket base plate respectively.

20. The thermal bracket assembly according to claim 19, wherein the first and second stiffener flanges are arranged to extend away from opposing surfaces of the bracket base plate.
